(19) United States
(12) Patent Application Publication
(10) Pub. No.: US 2003/0066361 A1
(43) Pub. Date: Apr. 10, 2003

(54) High accuracy turbine flowmeter using magnetic bearing

(76) Inventors: Chang Ho Kim, Seoul (KR); Yong Bok Lee, Seoul (KR); Seung Jong Kim, Seoul (KR); Joon Yong Yoon, Gyunggi-do (KR)

Correspondence Address: HARNESS, DICKEY & PIERCE, P.L.C., P.O. BOX 828, BLOOMFIELD HILLS, MI, 48303, US

(21) Appl. No.: 10/192,801

(22) Filed: Jul. 10, 2002

(30) Foreign Application Priority Data
Oct. 9, 2001 (KR) 2001-61996

(51) Int. Cl. G01F 1/05

(52) U.S. Cl. 73/861.79

(57) ABSTRACT

The present invention relates to a high accuracy turbine flowmeter using a magnetic bearing. More specifically, the object of the invention is to provide a method for enhancing the accuracy and reliability of a turbine flowmeter by improving the friction and wear-out effects occurring from the bearing parts through a non-contact support of the rotor in terms of a magnetic bearing.

### BACKGROUND OF THE INVENTION

The present invention relates to a high accuracy turbine flowmeter using a magnetic bearing. More particularly, the invention relates to a method for enhancing the accuracy and reliability of a sensor by improving the friction loss effect which cause a measurement error for flowmeters.

FIG. 1 illustrates the configuration of a conventional axial flow type turbine flowmeter. As shown in FIG. 1, the conventional axial flow type turbine flowmeter comprises a turbine rotor 1 with rotating blades 3 located inside of a cylindrical flow path, a magnetic pick up 5 which measures the rotating speed of the turbine rotor that is proportional to the speed of fluid, and a flow straightener 7 which is located at the front and rear of the turbine rotor 1.

The method of measuring the number of rotations using a turbine flowmeter typically involves counting the number of passes made by the ends of rotating blades 1 through a magnetic pick-up which exists as an electronic pick-up coil on the pipe wall and converting this count into an electronic pulse signal (or frequency component) in order to calculate the flow quantity.

Also, other methods involve measuring the rotation frequency by placing a Hall effect sensor observing the change in the flux density produced by the permanent magnets, which depends on the material property of the rotating blades.

Finally, the fluid quantity is calculated through a correction device by considering the relationship between the rotation frequency and fluid quantity, in this instance, the friction and fluid resistance around the rotating part are ignored.

The advantages for this type of turbine flowmeters are the high measurement accuracy and mechanical and electrical reliability, even for a low viscosity fluid. Moreover, it can also be used in a wide variety of temperature ranges as well as involving a large quantity of fluid.

Even so, however, the unavoidable friction occurring from sliding bearings and rolling bearings provided the cause for inaccuracy in measurement, contamination of fluid and shortening of a life span and the research has been concentrated to improve these short falls.

Recently, a flowmeter, which employs a double construction of a fixed turbine and a rotating rotor in order to have a high stability during a rapid change in the quantity of fluid and has a high accuracy flow measurement characteristic, has been introduced but it has a complicated construction and the cost is very high.

### SUMMARY OF THE INVENTION

The present invention is designed to overcome the above problems of prior art. The object of the invention is to provide a method for enhancing the accuracy and reliability of a turbine flowmeter by improving the friction and wear out effects occurring from the bearing parts through a non-contact support of the rotor in terms of a magnetic bearing.

The high accuracy axial flow type turbine flowmeter using a magnetic bearing according to the present invention, in which flow straighteners are constructed at both of the entry and exit sides of a rotor with blades, comprises a passive magnetic bearing construction which has a single contact point with a flow inductor at the entry side and has no contact with a flow straightener at the exit side using the repulsion force of permanent magnets.

Also, the other high accuracy axial flow type turbine flowmeter using a magnetic bearing according to the present invention comprises an active magnetic bearing which produces the magnetic levitation force in the radial direction in order to suppress the vibration and deflection by controlling the current flow in three or four electromagnets, while in the axial direction, the repulsive force between permanent magnets maintains a single contact point with the flow straightener at the entry side

### BRIEF DESCRIPTION OF THE DRAWINGS

FIG. 1 illustrates the configuration of a conventional axial flow type turbine flowmeter.

FIG. 2 shows a cross section of a turbine flowmeter construction installed with a passive type magnetic bearing.

FIG. 3 is the modeling of the permanent magnets in FIG. 2.

FIG. 4 shows a cross section of the construction of a turbine flowmeter installed with an active magnetic bearing.

FIG. 5 is the modeling of the active magnetic bearing in FIG. 4

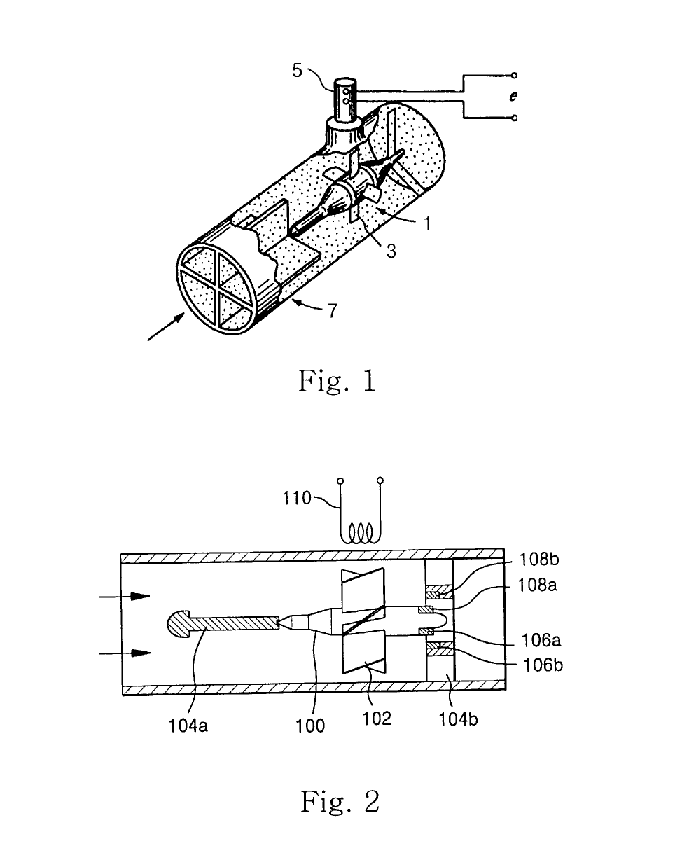

### DETAILED DESCRIPTION OF THE EMBODIMENTS

Hereinafter, preferred embodiments of the present invention will be described in detail with reference to accompanying drawings.

The type of bearings can be classified as passive and active types. The passive bearings which use a repulsive force between two permanent magnets, have a simple construction and are produced in a variety of shapes. The contact support or active bearings are necessary at least in one direction and for the sake of simplicity of construction and low manufacturing cost, a single point contact bearing is being used.

In case of using an active magnetic bearing, not only is it able to adjust the stiffness/damping characteristics of the bearing according to the type of fluid and flow condition of the subjected fluid but also able to measure the rotation frequency without any additional pick-up coil and monitor faulty operation of the flowmeter based on the measured signals from gap sensor or Hall effect sensor.

However, due to the complicated construction and high cost involved with employing sensors and controllers, it is preferable to use an active type in parallel with a passive type.

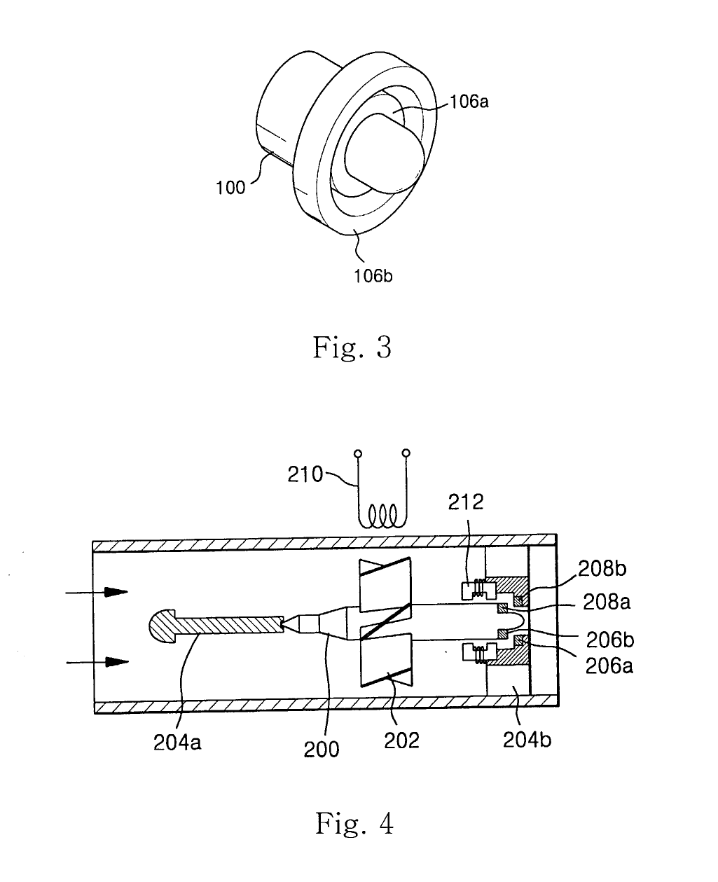

FIG. 2 shows a cross section of a turbine flowmeter construction installed with a passive magnetic bearing. FIG. 3 is the modeling of the permanent magnets in FIG. 2.

As shown in FIG. 2 and FIG. 3, it has an axial flow type turbine construction which has flow straighteners 104a, 104b constructed at both of the entry and exit sides of a turbine rotor 100 with rotating blades 102.

In this case, an electronic coil for detecting the number of rotation, more specifically, a magnetic pick up 110 is installed on the pipe wall of the flowmeter and a flow straightener 104b located at the rear of the rotor 100 comprises a pair of permanent magnets 106a, 106b, 108a, 108b which are magnetized in the radial direction. The magnetic fields for permanent magnets 106a, 106b, 108a, 108b are in the opposite direction.

The main role of the flow straighteners 104a, 104b is to reduce the margin of error due to a non-uniform flow but it also acts as a support. Conventionally, sliding bearings or rolling bearings are inserted between the flow straighteners and the rotor 100 but the key contribution of the present invention is to replace these bearings with magnetic bearings.

A design of a small type flowmeter as shown in FIG. 2, the rotor 100 at the exit side is supported by the repulsive force among the permanent magnets 106a, 106b, 108a, 108b and at the entry side with a flow inductor 104a, it is supported by a single point contact at the center.

In this instance, the location of permanent magnets in the axial direction can be designed as skewed in order to create a force in the axial direction. As a result, the pressure in the axial direction as well as a single point contact can be maintained.

If implemented for a large scale flow measurement, additional number of permanent magnets can be added to the permanent magnets 106a, 106b, 108a, 108b near the flow straightener at the entry side.

The factors which determine the characteristic of the bearings in the passive type are the type, size and width of permanent magnet. In this instance, in order to secure sufficient support stiffness, a Neodymium type which has superior magnetic field compare to a ferrite type is used.

The possible problems that can be anticipated from this kind of system are, firstly, the wear and friction occurring at the contact point, and secondly, a low damping expected from the passive type bearings. However, this system is substantially better in coping with wear and friction compared to the conventional system and a close analysis is necessary to ascertain the effect of left-over vibration from the damping on the measurement accuracy in order to minimize the error. Finally, in order to obtain the rotation speed, the same method to apply to the conventional flowmeter can be used.

In case of applying an active magnetic bearing, there are two types which utilize the attractive force or the Lorenz force method. An appropriate selection should be made in due consideration of the simplicity of construction as well as the total size. The Lorenz type has the advantage of not being affected by eddy current and hysteresis but it has a relatively complicated construction and weak force.

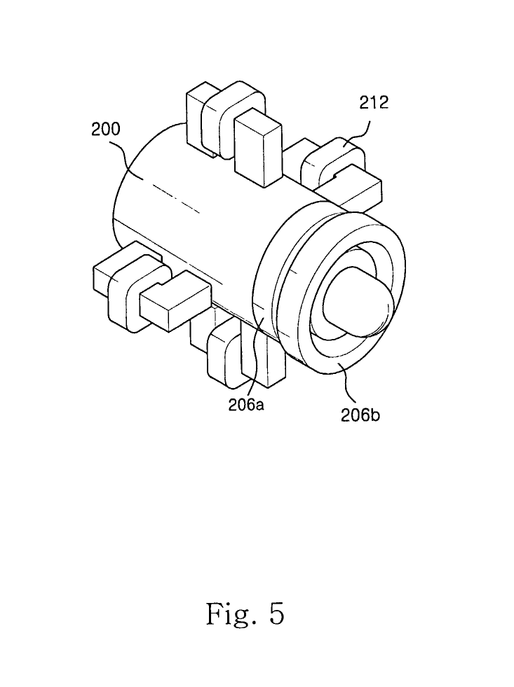

FIG. 4 shows a cross section of the construction of a turbine flowmeter installed with an active magnetic bearing. FIG. 5 is the modeling of the active magnetic bearing in FIG. 4

FIG. 4 and FIG. 5 show a turbine flowmeter with the sane basic structure in FIG. 2 but the passive magnetic bearing is replaced with an active type. By controlling the current which flows in 4 electromagnets 212, the rotor 200 is electro-magnetically levitated, and an additional pair of permanent magnets 206a, 206b, 208a, 208b are added so as to exert a force in axial direction which pushes the rotor 200 into the entry side.

In case of introducing active magnetic bearings such as above, the related technologies developed since 1980 such as self-sensing, auto-balancing, self-diagnosis and monitoring technologies can be adopted easily resulting an added advantage in the performance.

The high accuracy turbine flowmeter using magnetic bearings according to the present invention has the following advantages.

Firstly, according to the present invention, it is not only capable of accurately measuring the flow quantity but also completely eradicates the fluid contamination from the lubricating oils.

Secondly, according to the present invention, it is safe to use for measuring the flow of a flammable fluid or natural gas since there is no occurrence of sparks or heating up due to friction.

Hence, it can be used for the existing application areas as well as for high purity fluids, beverages. Also, it has a long life span with an implication of cost saving in the long term.

What is claimed is:

1. A high accuracy axial flow type turbine flowmeter using a magnetic bearing, in which flow straighteners are constructed at both of the entry and exit sides of a turbine rotor with rotating blades, and an electronic pick-up coil is installed on the pipe wall, comprising a passive magnetic bearing construction which has a single contact point with a flow inductor at the entry side and maintains no contact with a flow straightener at the exit side using a repulsive force between permanent magnets.

2. The high accuracy axial flow type turbine flowmeter using a magnetic bearing, as claimed in claim 1 wherein said passive magnetic bearing is essentially a pair of permanent magnets magnetized in the radial direction whose axial directions are skewed.

3. A high accuracy axial flow type turbine flowmeter using an active magnetic bearing wherein a single contact point with a flow straightener at the entry side is maintained using the magnetic levitation force in the radial direction by controlling the current flow in a small number of electromagnets and the repulsive force of permanent magnets in the axial direction.

4. The high accuracy axial flow type turbine flowmeter, as claimed in claim 3 wherein said turbine flowmeter is capable of self-assessing the reliability of the flow measurement using a self monitoring and self diagnostic functions.
